(19) United States
(12) Patent Application Publication
(10) Pub. No.: US 2009/0254606 A1
(43) Pub. Date: Oct. 8, 2009

(54) NETWORK MANAGEMENT FILTER SYSTEM

(75) Inventors: John Power, Waterford (IE); Edwin Tse, Montreal (CA)

Correspondence Address: HARRITY & HARRITY, LLP, 11350 RANDOM HILLS RD., SUITE 600, FAIRFAX, VA, 22030, US

(73) Assignee: TELEFONAKTIEBOLAGET LM ERICSSON, Stockholm (SE)

(21) Appl. No.: 12/098,681

(22) Filed: Apr. 7, 2008

(51) Int. Cl. G06F 15/16

(52) U.S. Cl. 709/203

(57) ABSTRACT

A device associated with a network receives, from a requestor, a request for managed object information filtered based on a managed object attribute, and identifies a managed object based on the request. The device identifies, based on the request, the managed object attribute from the identified managed object, and provides the identified managed object attribute to the requestor.

### TECHNICAL FIELD

Embodiments described herein relate generally to communication systems, and, more particularly, to filtering of network management information in a telecommunication system.

### BACKGROUND

Current network management solutions for telecommunication systems may include the International Telecommunication Union Telecommunication Standardization Sector's (ITU-T) Telecommunication Management Network (TMN), the Third Generation Partnership Project's (3GPP) Integration Reference Point, the Third Generation Partnership Project 2's (3GPP2) Integration Reference Point, and the Internet Engineering Task Force's (IETF) Simple Network Management Protocol (SNMP). Current network management solutions for telecommunication systems use a client-server, hierarchical architecture to manage flow of network management information (NMI) (e.g., information associated with operation, administration, maintenance, provisioning, etc. of telecommunication systems). For example, each level of the client-server, hierarchical architecture maintains a database of managed objects (MOs). Each managed object may include an abstract representation of data processing (e.g., network functions) or data communication resources (e.g., devices) that are managed. In telecommunication system management, a “managed object” may include a resource within the telecommunication system that may be managed through the use of operation, administration, maintenance, and provisioning (OAMP) protocols. Managed objects may be stored in a database created and/or maintained by a server. Such a database may be referred to as a Management Information Base (MIB).

The definitions (e.g., schema) of the managed objects are known by a client and a server. When a client wants information associated with certain managed objects, the client creates and sends a request to the server. The client uses the constraint (or criteria), expressed by the request, to identify the desired managed objects from the server's managed object database. The server locates the identified managed objects from its database and acts on the identified managed objects. For example, the server may return information associated with the identified managed objects to the client.

Network nodes and functions represented by managed objects are dynamic in that their state changes over time. The changes are conveyed by the server to the client via notifications. A notification is a message with a number of parameters. The types of notifications and the notification parameters are known by the client and the server.

Such client-server, hierarchical architectures have several disadvantages. For example, the client can identify the managed objects (e.g., via a request), and the server will return all of the information associated with the identified managed objects. However, the client is unable to indicate that only a portion (rather than all) of the information associated with the identified managed objects is desired. Furthermore, the client can identify the types of network management notifications to be received, but is unable to indicate that only a portion (rather than all) of the identified notifications is desired.

### SUMMARY

It is an object of the invention to overcome at least some of the above disadvantages and to filter network management information (e.g., managed object information and notifications) so that a portion of information associated with identified managed objects and a portion of identified notifications may retrieved (e.g., by a client).

Embodiments described herein may provide systems and/or methods that filter network management information (e.g., managed object information and/or notifications). For example, in one embodiment, the systems and/or methods may include a client device (e.g., a device that receives managed object information and/or notifications, such as a network element), and a server device (e.g., a device that stores, maintains, and/or provides managed object information and/or notifications to the client device). The server device may store the managed object information and the notifications in a database. The managed object information may include managed object attributes. A managed object attribute may include a property that includes a value, and may be either mandatory or conditional. Mandatory initial values for managed object attributes may be specified as part of a managed object class definition. Attribute names and semantics for each class of managed object may be specified by the managed object class schema, and may be known to both the client device and the server device. The client device may retrieve a portion of managed object information from the server device by filtering (e.g., via a managed object information request) the managed object information based on managed object attributes.

In another embodiment, because network nodes and functions represented by managed objects may be dynamic (e.g., their state may change over time), values associated with managed object attributes may change. The changes may be conveyed to the client device via the notifications. A notification may include a message with a number of notification parameters. The types of notification and the notification parameters may be specified by and/or known to both the client device and the server device. For example, the client device may subscribe to and/or receive a portion of the notifications from the server device by filtering (e.g., via a notification subscription) the notifications based on notification parameters.

In an exemplary embodiment, systems and/or methods described herein may receive, from a requester (e.g., the client device), a request for managed object information filtered based on managed object attributes, and may identify managed objects based on the request. The systems and/or methods may identify, based on the request, managed object attributes from the identified managed objects, and may provide the identified managed object attributes to the requestor. The systems and/or methods may receive, from the requester, a subscription for notifications filtered based on notification parameters, and may identify notification types based on the subscription. The systems and/or methods may identify notification parameters, based on the subscription, from the identified notification types, and may provide the identified notification parameters to the requestor.

Embodiments described herein may provide a variety of advantages. For example, the managed object attribute filter described herein may permit very fine grained queries to be executed on network management information that is not supported in current systems. When current systems query one attribute from large datasets (e.g., a telecommunication system that includes tens of thousands of managed objects), the query results in an enormous amount of information being retrieved, including all managed object attributes. This is time consuming and requires a significant amount of bandwidth to transfer data that is ultimately not required. The managed object attribute filter described herein may prevent such as result.

In scenarios where only a status (e.g., whether there is a critical alarm or not) of a managed object is desired, current systems forward all notification information, including all details of the alarms. The notification parameter filter described herein prevents such a result. For example, with the notification parameter filter described herein, it is possible to filter based on high level data, and to collect details required for troubleshooting based on the filtered high level data.

### BRIEF DESCRIPTION OF THE DRAWINGS

FIG. 1 depicts a diagram of an exemplary network in which systems and/or methods described herein may be implemented;

FIG. 2 illustrates exemplary components of a client and/or a server of the network depicted in FIG. 1;

FIG. 3 depicts a diagram of an exemplary portion of the network illustrated in FIG. 1 and exemplary interactions among components of the network portion;

FIG. 4 illustrates a diagram of an exemplary portion of a database capable of being generated, stored, and/or maintained by the server of the network depicted in FIG. 1;

FIG. 5 depicts a diagram of exemplary elements of managed object information capable of being generated by the client of the network illustrated in FIG. 1;

FIG. 6 illustrates a diagram of exemplary elements of a managed object information request capable of being generated by the client of the network depicted in FIG. 1;

FIG. 7 depicts a diagram of exemplary elements of a notification subscription capable of being generated by the client of the network illustrated in FIG. 1; and

FIGS. 8-13 depict flow charts of exemplary processes for filtering managed object information and/or notifications according to embodiments described herein.

### DETAILED DESCRIPTION

The following detailed description refers to the accompanying drawings. The same reference numbers in different drawings may identify the same or similar elements. Also, the following detailed description does not limit the invention.

Embodiments described herein may provide systems and/or methods that filter managed object information and/or notifications based on managed object attributes and/or notification parameters, respectively.

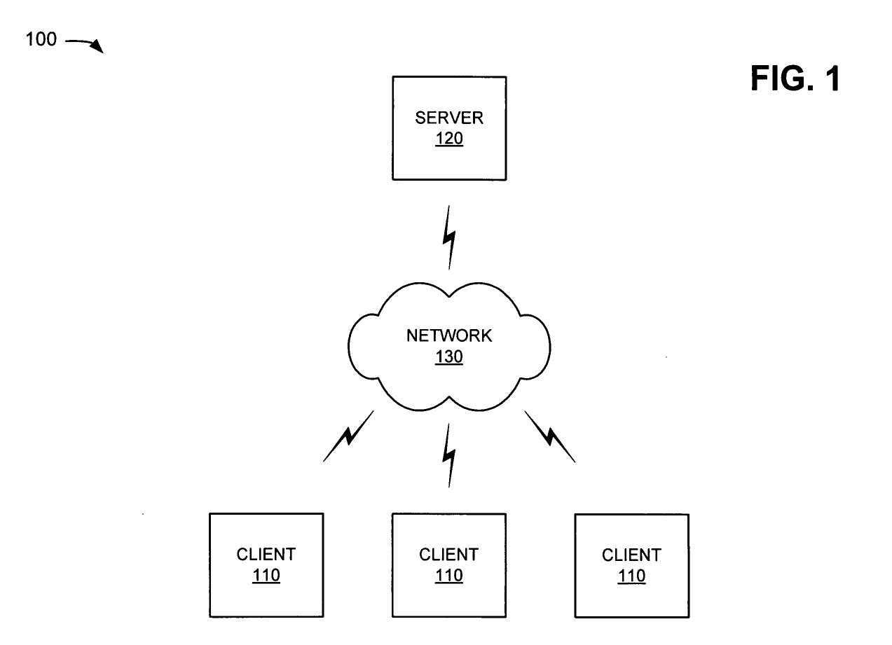

FIG. 1 depicts a diagram of an exemplary network 100 in which systems and/or methods described herein may be implemented. As illustrated, network 100 may include clients 110 and a server 120 interconnected by a network 130. Clients 110 and/or server 120 may connect to network 130 via wired and/or wireless connections. Three clients, a single server, and a single network have been illustrated in FIG. 1 for simplicity. In practice, there may be more clients, servers, and/or networks. Also, in some instances, a component in network 100 (e.g., one or more of clients 110 and/or server 120) may perform one or more functions described as being performed by another component or group of components in network 100. For example, in one embodiment, one of clients 110 may act as a server, and server 120 may act as a client.

Each of clients 110 may include any device capable of generating and/or receiving data (e.g., network management information (NMI)) associated with network 100. For example, each of clients 110 may include a computer, a router, a switch, a network interface card (NIC), a hub, a bridge, a gateway, a firewall, a proxy server, an optical add-drop multiplexer (OADM), some other type of device that processes and/or transfers data, another type of computation or communication device, a thread or process running on one of these devices, and/or an object executable by one of these devices. In one embodiment, each of clients 110 may include a node of a telecommunication network.

The term “data,” as used herein, is to be broadly construed to include any information capable of being generated by network 100 and/or any component of network 100 (e.g., clients 110 and/or server 120), such as information associated with operation, administration, maintenance, provisioning, etc. of telecommunication systems, managed object information, notifications, etc.

Server 120 may include one or more server entities, or other types of computation or communication devices, that gather, process, search, and/or provide information (e.g., network management information (NMI)) in a manner described herein. For example, server 120 may include a computer, a router, a switch, a network interface card (NIC), a hub, a bridge, a gateway, a firewall, a proxy server, an optical add-drop multiplexer (OADM), some other type of device that processes and/or transfers data, another type of computation or communication device, a thread or process running on one of these devices, and/or an object executable by one of these devices. In one embodiment, server 120 may include a node of a telecommunication network.

Network 130 may include a local area network (LAN), a wide area network (WAN), a metropolitan area network (MAN), an intranet, the Internet, a Public Land Mobile Network (PLMN), a telephone network, such as the Public Switched Telephone Network (PSTN) or a cellular telephone network, or a combination of networks. In one exemplary embodiment, network 130 may include a telecommunication network.

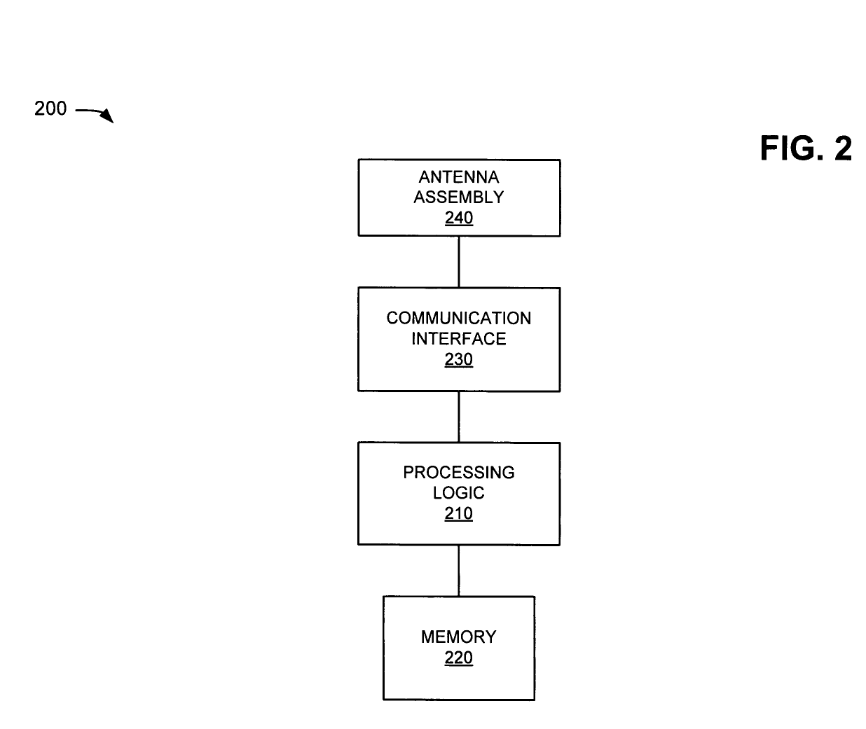

FIG. 2 is an exemplary diagram of a device 200 that may correspond to one of clients 110 and/or server 120. As illustrated, device 200 may include processing logic 210, memory 220, a communication interface 230, and/or an antenna assembly 240.

Processing logic 210 may include a processor, microprocessor, an application specific integrated circuit (ASIC), a field programmable gate array (FPGA), or the like. Processing logic 210 may control operation of device 200 and its components.

Memory 220 may include a random access memory (RAM), a read only memory (ROM), and/or another type of memory to store data and instructions that may be used by processing logic 210.

Communication interface 230 may include any transceiver-like mechanism that enables device 200 to communicate with other devices and/or systems. Communication interface 230 may include, for example, a transmitter that may convert baseband signals from processing logic 210 to radio frequency (RF) signals and/or a receiver that may convert RF signals to baseband signals. Alternatively, communication interface 230 may include a transceiver to perform functions of both a transmitter and a receiver. Communication interface 230 may connect to antenna assembly 240 for transmission and/or reception of the RF signals.

Antenna assembly 240 may include one or more antennas to transmit and/or receive RF signals over the air. Antenna assembly 240 may, for example, receive RF signals from communication interface 230 and transmit them over the air and receive RF signals over the air and provide them to communication interface 230. In one exemplary embodiment, for example, communication interface 230 may communicate via a network (e.g., network 130). Additionally and/or alternatively, communication interface 230 may communicate with a network (e.g., network 130) via one or more physical links.

As described herein, device 200 may perform certain operations in response to processing logic 210 executing software instructions contained in a computer-readable medium, such as memory 220. A computer-readable medium may be defined as a physical or logical memory device. The software instructions may be read into memory 220 from another computer-readable medium or from another device via communication interface 230. The software instructions contained in memory 220 may cause processing logic 210 to perform processes described herein. Alternatively, hardwired circuitry may be used in place of or in combination with software instructions to implement processes described herein. Thus, embodiments described herein are not limited to any specific combination of hardware circuitry and software.

In one exemplary embodiment, device 200 may include mechanisms for inputting information to device 200 and/or for outputting information from device 200. Examples of input and output mechanisms might include buttons, a keyboard, a mouse, a pen, a microphone, voice recognition and/or biometric mechanisms, a display, a printer, a speaker, etc.

Although FIG. 2 shows exemplary components of device 200, in other embodiments, device 200 may contain fewer, different, or additional components than depicted in FIG. 2. In still other embodiments, one or more components of device 200 may perform one or more other tasks described as being performed by one or more other components of device 200.

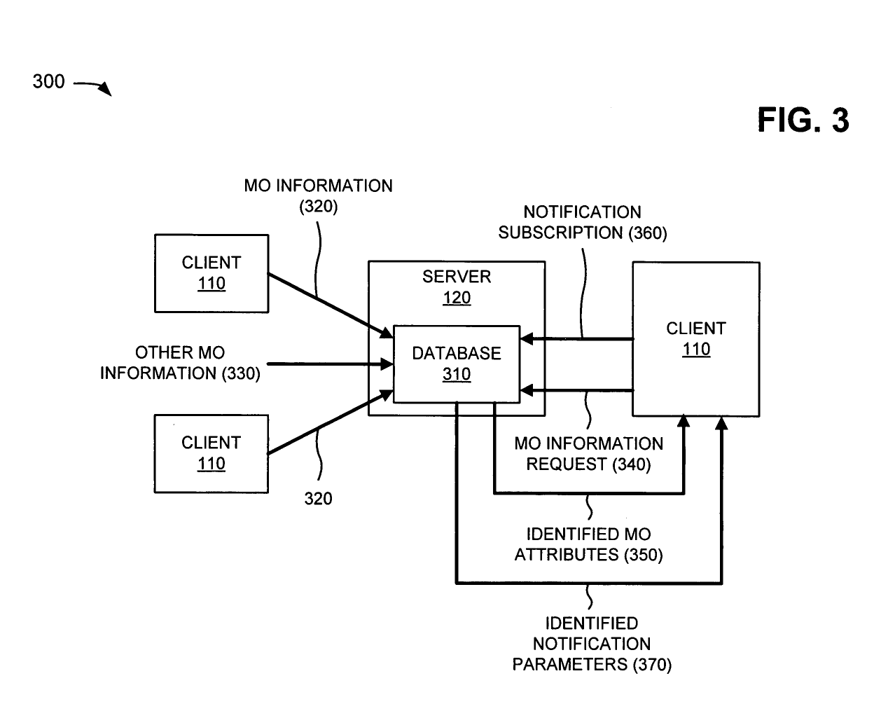

FIG. 3 depicts a diagram of an exemplary portion 300 of network 100 and exemplary interactions among components of network portion 300. As illustrated, network portion 300 may include clients 110 and server 120. Clients 110 and server 120 may include the features described above in connection with FIG. 1.

Server 120 may store information, such as managed objects, managed object information, managed object attributes, notifications, etc., in a database 310. In one embodiment, database 310 may be generated, stored, and/or maintained by server 120 (e.g., within memory 220). In another embodiment, database 310 may be generated, stored, and/or maintained by a device other than or in addition to server 120. In one example, database 310 may correspond to a Management Information Base (MIB). As shown in FIG. 3, clients 110 may provide managed object information 320 to database 310. Other managed object information 330 may be provided to database 310 via other devices (not shown) associated with a network (e.g., network 130).

If one of clients 110 wishes to retrieve managed object information from database 310, client 110 may generate and provide a managed object information request 340 to server 120. Managed object information request 340 may include information associated with a managed object class name, one or more managed object attributes associated with the managed object class, and/or other request information. Server 120 may receive managed object information request 340, may compare managed object information request 340 to the information contained in database 310, and may generate identified managed object attributes 350 based on the comparison. For example, in one embodiment, server 120 may identify a set of managed objects based on the managed object class name provided in managed object information request 340. Server 120 may use the one or more managed object attributes provided in managed object information request 340 to identify a subset of managed object attributes (e.g., identified managed object attributes 350) from the set of identified managed objects. Server 120 may provide identified managed object attributes 350 to client 110.

As further shown in FIG. 3, if client 110 wishes to subscribe to notifications from database 310, client 110 may generate and provide a notification subscription 360 to server 120. Notification subscription 360 may include information associated with a notification type, one or more notification parameters associated with the notification type, and/or other subscription information. For example, notification subscription 360 may request that alarms (e.g., a notification type) associated with a managed object, if the occur, be provided to client 110. Notification subscription 360 may further request that only critical alarms (e.g., a notification parameter) associated with the managed object, if they occur, be provided to client 110.

Server 120 may receive notification subscription 360, may compare notification subscription 360 to the information contained in database 310, and may generate notifications filtered based on notification parameters 370 identified by the comparison (e.g., if such notification parameters 370 occur). For example, in one embodiment, server 120 may identify a set of notification types based on the notification type provided in notification subscription 360. Server 120 may use the one or more notification parameters provided in notification subscription 360 to identify a subset of notification parameters (e.g., identified notification parameters 370) from the set of identified notification types. Server 120 may provide notifications filtered based on identified notification parameters 370 to client 110 (e.g., if notification parameters 370 occur).

Unlike current telecommunication system management schemes, the client devices (e.g., clients 110) described herein may retrieve a portion of managed object information from a server device (e.g., server 120) by filtering (e.g., via managed object information request 340) the managed object information based on managed object attributes. Furthermore, unlike current telecommunication system management schemes, the client devices (e.g., clients 110) described herein may subscribe to and/or receive a portion of notifications from the server device (e.g., server 120) by filtering (e.g., via notification subscription 360) the notifications based on notification parameters.

Although FIG. 3 shows exemplary components of network portion 300, in other embodiments, network portion 300 may contain fewer, different, or additional components than depicted in FIG. 3. In still other embodiments, one or more components of network portion 300 may perform one or more other tasks described as being performed by one or more other components of network portion 300.

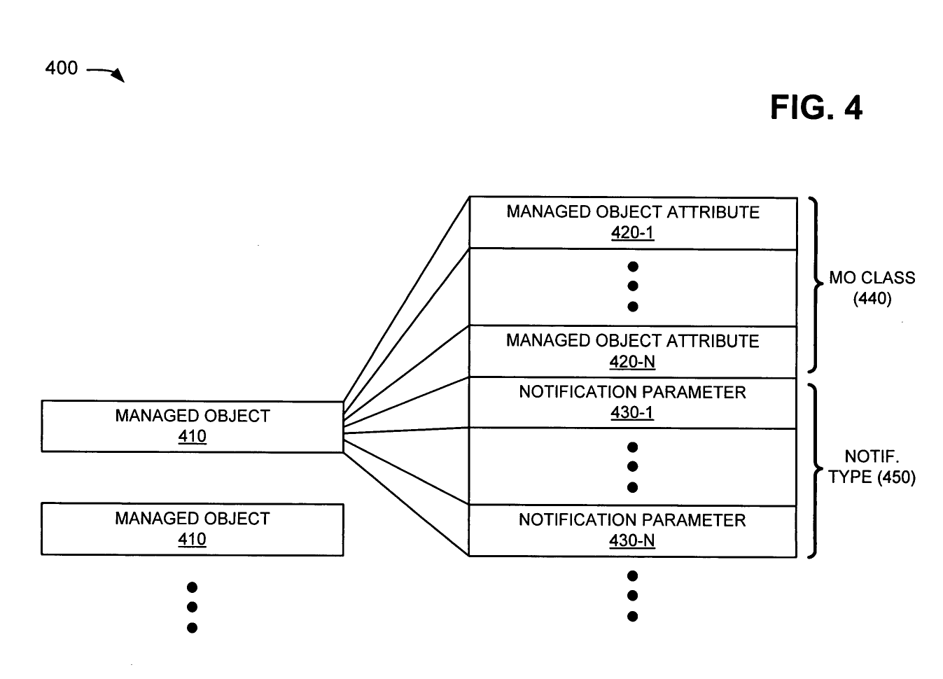

FIG. 4 illustrates a diagram of an exemplary portion 400 of database 310. As illustrated in FIG. 4, database portion 400 may include one or more managed object fields 410. Each managed object field 410 may include one or more managed object attributes 420-1, . . . , 420-N (collectively referred to as “managed object attributes 420,” and individually as “managed object attribute 420”), and one or more notification parameters 430-1, . . . , 430-N (collectively referred to as “notification parameters 430,” and individually as “notification parameter 430”). Managed object attributes 420 may collectively make up a managed object class 440. Notification parameters 430 may collectively make up a notification type 450. Although not shown in FIG. 4, database portion 400 may include other managed object classes 440 and/or other notification types 450.

Managed object field 410 may include an abstract representation of data processing (e.g., network functions) or data communication resources (e.g., devices) that are managed. In telecommunication system management, managed object field 410 may include a resource within the telecommunication system (e.g., network 130) that may be managed through the use of operation, administration, maintenance, and provisioning (OAMP) protocols.

Managed object attributes 420 may include properties of a managed object (e.g., managed object field 410) that include values. Mandatory initial values for managed object attributes 420 may be specified as part of a managed object class definition. In one embodiment, for example, managed object attributes 420 may include attribute names and/or semantics. Attribute names and semantics for each class of managed object may be specified by the managed object class schema, and may be known to both clients 110 and server 120.

Notification parameters 430 may include information associated with notifications (e.g., messages indicating changes to managed objects (e.g., managed object fields 410) upon occurrence of events, such as changes to values associated with managed object attributes 420). For example, in one embodiment, notification parameters 430 may identify information used to further describe notifications associated with a managed object (e.g., managed object field 410).

Managed object class 440 may define characteristics of a type of physical or logical resource. For example, in one embodiment, instances of managed object class 440 may exist to represent specific instances of a resource. Therefore, managed objects (e.g., managed object fields 410) and/or managed object attributes 420 may be instances of managed object class 440.

Notification type 450 may include information that identifies a type of notification associated with a managed object (e.g., managed object field 410). For example, in one embodiment, notification type 450 may include one or more notification parameters 430.

In one exemplary embodiment, the information contained in database portion 400 may be provided to server 120 by clients 110 (e.g., via managed object information 320). In another exemplary embodiment, the information contained in database portion 400 may be provided to server 120 by other devices (e.g., via other managed object information 330).

Although FIG. 4 shows exemplary elements of database portion 400, in other embodiments, database portion 400 may contain fewer, different, or additional elements than depicted in FIG. 4.

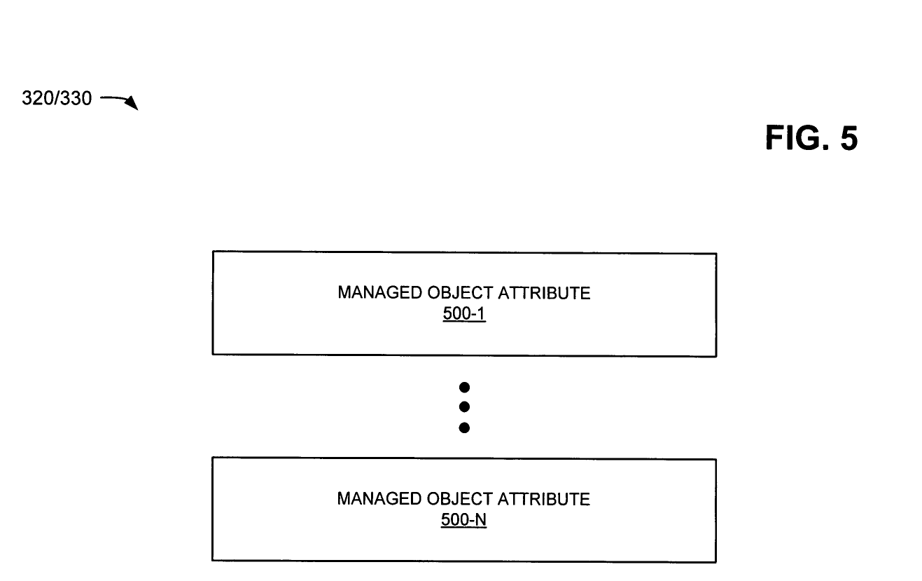

FIG. 5 depicts a diagram of exemplary elements of managed object information 320 and/or other managed object information 330. In one embodiment, managed object information 320/330 may be generated by clients 110. In another embodiment, managed object information 320/330 may be generated by a device (e.g., server 120) other than or in addition to clients 110. As illustrated, managed object information 320/330 may include one or more managed object attributes 500-1, . . . , 500-N (collectively referred to as “managed object attributes 500,” and individually as “managed object attribute 500”).

Managed object attributes 500 may include properties of a managed object (e.g., managed object field 410) that include values. Mandatory initial values for managed object attributes 500 may be specified as part of a managed object class definition. In one embodiment, for example, managed object attributes 500 may include attribute names and/or semantics. Attribute names and semantics for each class of managed object may be specified by the managed object class schema, and may be known to both clients 110 and server 120.

Although FIG. 5 shows exemplary elements of managed object information 320/330, in other embodiments, managed object information 320/330 may contain fewer, different, or additional elements than depicted in FIG. 5.

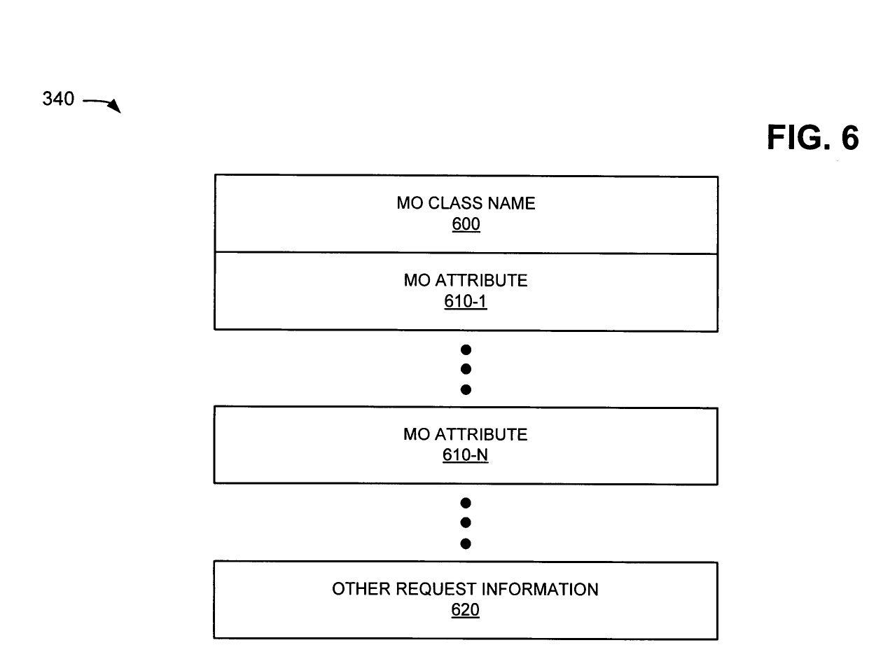

FIG. 6 illustrates a diagram of exemplary elements of managed object information request 340. In one embodiment, managed object information request 340 may be generated by a client (e.g., one of clients 110). In another embodiment, managed object information request 340 may be generated by a device other than or in addition to client 110. As illustrated, managed object information request 340 may include a managed object class name field 600, one or more managed object attribute fields 610-1, . . . , 610-N (collectively referred to as “managed object attribute fields 610,” and individually as “managed object attribute field 610”), and/or other request information field 620.

Managed object class name field 600 may include information that identifies a managed object class to be retrieved. For example, in one embodiment, manage object class name field 600 may include information that identifies managed object class 440 provided in database portion 400, as described above in connection with FIG. 4.

Managed object attribute fields 610 may include information that identifies one or more managed object attributes to be retrieved from the managed object class identified by managed object class name field 600. For example, in one embodiment, managed object attribute fields 610 may include information that identifies one or more managed object attributes 420 provided in database portion 400, as described above in connection with FIG. 4.

Other request information 620 may include information that identifies managed object information to be retrieved. For example, in one embodiment, other request information 620 may include information that identifies one or more managed object fields 410 provided in database portion 400, as described above in connection with FIG. 4. In an exemplary embodiment, other request information 620 may include a parameter (e.g., “sessionId”) identifying a session associated with managed object information to be retrieved, a parameter (e.g., “uploadDataFileReference”) identifying a complete path of a file associated with managed object information to be retrieved, a base object parameter (e.g., “baseObjectInstance”) identifying a managed object class associated with managed object information to be retrieved, a scope parameter defining a type of scoping used for a request operation, and/or a filter parameter defining a filter to be passed by objects selected by the scope parameter.

In one exemplary embodiment, managed object class name field 600 and managed object attribute fields 610 may correspond to a managed object attribute filter that filters managed object information (e.g., information contained in database portion 400) based on managed object attributes. The managed object attribute filter may include a sequence pair (e.g., a 2-tuple) of values (or components). For example, using the Eiffel object-oriented programming language, the managed object attribute filter may be expressed as TUPLE[X, Y]. The element X of the pair may be used to express a managed object class name (e.g., managed object class name field 600). The element Y of the pair may include one or more 1-tuples (or singletons). Each singleton may be used to express a name of a managed object attribute (e.g., managed object attribute fields 610) associated with the managed object class name expressed by element X.

In one embodiment, the managed object attribute filter may include the following construct:

{
{“MMEFunction”, {“id”, “userlabel”, “state”}}, {“ENBFunction”,
{“id”}}
},

where {“MMEFunction”, {“id”, “userlabel”, “state”}} may correspond to element X of the pair (e.g., managed object class name field 600), and {“ENBFunction”, {“id”}} may correspond to element Y of the pair (e.g., managed object attribute fields 610). The construct may include two 2-tuples, and may indicate that the managed object attribute filter seeks to retrieve attributes “id” and “userlabel” of instances of “MMEFunction”, and attributes of “id” of instances of “ENBFunction”. The description of the language used in the construct is exemplary. In other embodiments, different syntax or encoding of the construct may be employed depending on a protocol used by clients 110 and/or server 120.

If one of clients 110 wishes to retrieve managed object information from database 310 of server 120, client 110 may generate and provide managed object information request 340 to server 120. Server 120 may receive managed object information request 340, may compare one or more portions of managed object information request 340 to the information contained in database 310, and may generate identified managed object attributes 350 based on the comparison. For example, in one embodiment, server 120 may identify a set of managed objects based on managed object class name field 600 and/or other request information 620 (e.g., the base object, scope, and/or filter parameters) provided in managed object information request 340. Server 120 may use managed object attribute fields 610 provided in managed object information request 340 to identify a subset of managed object attributes (e.g., identified managed object attributes 350) from the set of identified managed objects.

Although FIG. 6 shows exemplary elements of managed object information request 340, in other embodiments, managed object information request 340 may contain fewer, different, or additional elements than depicted in FIG. 6.

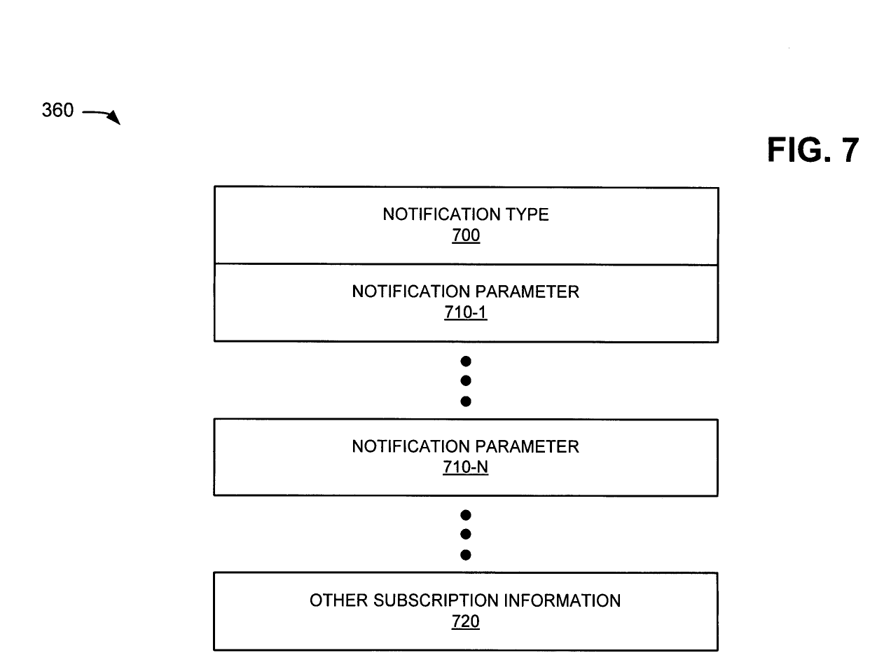

FIG. 7 depicts a diagram of exemplary elements of notification subscription 360. In one embodiment, notification subscription 360 may be generated by a client (e.g., one of clients 110). In another embodiment, notification subscription 360 may be generated by a device other than or in addition to client 110. As illustrated, notification subscription 360 may include a notification type field 700, one or more notification parameter fields 710-1, . . . , 710-N (collectively referred to as “notification parameter fields 710,” and individually as “notification parameter field 710”), and/or other subscription information field 720.

Notification type field 700 may include information that identifies a type of notification to be retrieved (e.g., an alarm associated with a managed object). For example, in one embodiment, notification type field 700 may include information that identifies notification type 450 provided in database portion 400, as described above in connection with FIG. 4.

Notification parameter fields 710 may include information that identifies one or more notification parameters (e.g., critical alarms) to be retrieved from the notification type (e.g., an alarm associated with a managed object) identified by notification type field 700. For example, in one embodiment, notification parameter fields 710 may include information that identifies one or more of notification parameters 430 provided in database portion 400, as described above in connection with FIG. 4.

Other subscription information 720 may include information that identifies notifications to be retrieved. For example, in one embodiment, other subscription information 720 may include information that identifies notifications associated with one or more managed object fields 410 provided in database portion 400, as described above in connection with FIG. 4. In an exemplary embodiment, other subscription information 720 may include a parameter (e.g., “managerReference”) identifying a device to which notifications are to be sent, a parameter (e.g., “timeTick”) identifying a value of a hold time associated with notifications, a parameter identifying one or more notification categories, and/or a parameter identifying a filter associated with notifications to be retrieved.

In one exemplary embodiment, notification type field 700 and notification parameter fields 710 may correspond to a notification parameter filter that filters notifications (e.g., information contained in database portion 400) based on notification parameters. The notification parameter filter may include a sequence pair (e.g., a 2-tuple) of values (or components). For example, using the Eiffel object-oriented programming language, the notification parameter filter may be expressed as TUPLE[X, Y]. The element X of the pair may be used to express a notification type (e.g., notification type field 700). The element Y of the pair may include one or more 1-tuples (or singletons). Each singleton may be used to express a name of a notification parameter (e.g., notification parameter fields 710) associated with the notification type expressed by element X.

In one embodiment, the notification parameter filter may include the following construct:

{
{“notifyNewAlarm”, {“notificationId”, “objectInstance”, “severity”}},
{“notifyManagedObjectCreation” ,{“objectClass”, “objectInstance”,
“state”}}
},

where {“notifyNewAlarm”, {“notificationId”, “objectInstance”, “severity”}} may correspond to element X of the pair (e.g., notification type field 700), and {“notifyManagedObjectCreation”, {“objectClass”, “objectInstance”, “state”}} may correspond to element Y of the pair (e.g., notification parameter fields 710). The construct may include two 2-tuples, and may indicate that the notification parameter filter seeks to retrieve parameters “notificationId”, “objectInstance”, and “severity” of notification type “notifyNewAlarm”, and parameters “notificationId”, “objectClass”, and “objectInstance” of notification type “notifyManagedObjectCreation”. The description of the language used in the construct is exemplary. In other embodiments, different syntax or encoding of the construct may be employed depending on a protocol used by clients 110 and/or server 120.

If client 110 wishes to subscribe to notifications from database 310 of server 120, client 110 may generate and provide notification subscription 360 to server 120. Server 120 may receive notification subscription 360, may compare one or more portions of notification subscription 360 to the information contained in database 310, and may generate notifications, filtered based on notification parameters 370 identified by the comparison. For example, in one embodiment, server 120 may identify a set of notification types based on notification type field 700 provided in notification subscription 360. Server 120 may use notification parameter fields 710 provided in notification subscription 360 to identify a subset of notification parameters (e.g., identified notification parameters 370) from the set of identified notification types.

Although FIG. 7 shows exemplary elements of notification subscription 360, in other embodiments, notification subscription 360 may contain fewer, different, or additional elements than depicted in FIG. 7.

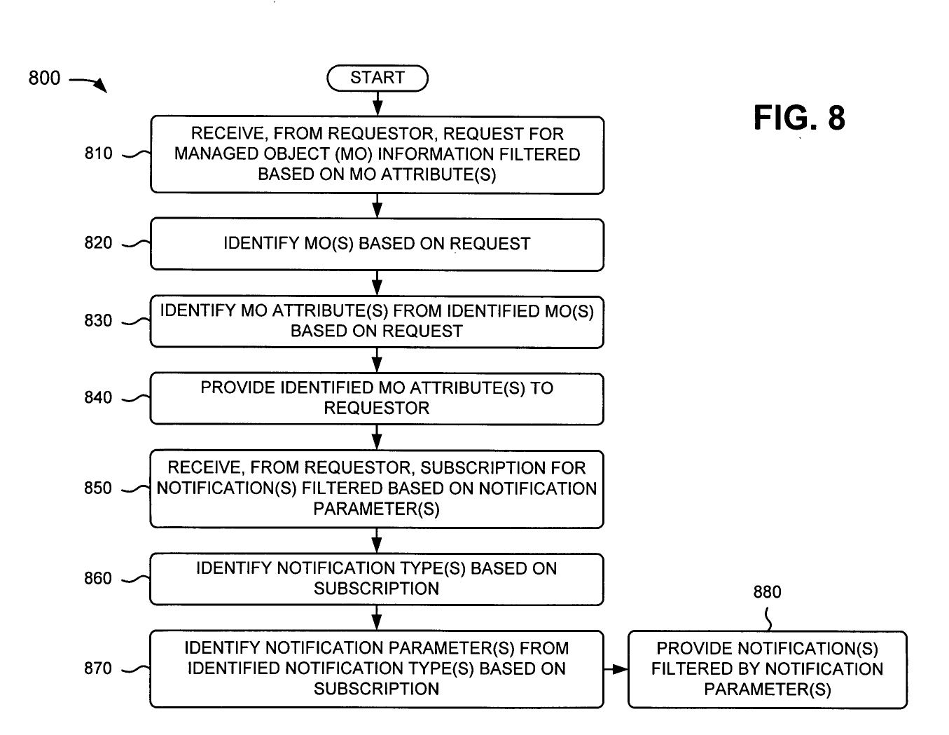

FIGS. 8-10 depict flow charts of an exemplary process 800 for providing filtered managed object information and/or notifications according to embodiments described herein. In one embodiment, process 800 may be performed by hardware and/or software components of server 120. In other embodiments, process 800 may be performed by hardware and/or software components of server 120 in combination with hardware and/or software components of another device (e.g., communicating with server 120).

As illustrated in FIG. 8, process 800 may begin with receipt, from a requester, of a request for managed object information filtered based on one or more managed object attributes (block 810), and identification of one or more managed objects based on the request (block 820). For example, in embodiments described above in connection with FIG. 3, if one of clients 110 wishes to retrieve managed object information from database 310, client 110 may generate and provide managed object information request 340 to server 120. Managed object information request 340 may include information associated with a managed object class name, one or more managed object attributes associated with the managed object class, and/or other request information. In one example, server 120 may identify a set of managed objects based on the managed object class name provided in managed object information request 340.

Returning to FIG. 8, one or more managed object attributes may be identified from the one or more identified managed objects based on the request (block 830), and the one or more identified managed object attributes may be provided to the requestor (block 840). For example, in embodiments described above in connection with FIG. 3, server 120 may receive managed object information request 340, may compare one or more portions of managed object information request 340 to the information contained in database 310, and may generate identified managed object attributes 350 based on the comparison. In one example, server 120 may use the one or more managed object attributes provided in managed object information request 340 to identify a subset of managed object attributes (e.g., identified managed object attributes 350) from the set of identified managed objects. Server 120 may provide identified managed object attributes 350 to client 110.

As further shown in FIG. 8, a subscription for one or more notifications, filtered based on one or more notification parameters, may be received from the requestor (block 850), and one or more notification types may be identified based on the subscription (block 860). For example, in embodiments described above in connection with FIG. 3, if client 110 wishes to subscribe to notifications from database 310 of server 120, client 110 may generate and provide notification subscription 360 to server 120. Notification subscription 360 may include information associated with a notification type, one or more notification parameters associated with the notification type, and/or other subscription information. In one example, server 120 may identify a set of notification types based on the notification type provided in notification subscription 360.

Returning to FIG. 8, one or more notification parameters may be identified from the one or more identified notification types based on the subscription (block 870), and notifications filtered based on the one or more identified notification parameters may be provided to the requester (block 880). For example, in embodiments described above in connection with FIG. 3, server 120 may receive notification subscription 360, may compare one or more portions of notification subscription 360 to the information contained in database 310, and may generate notifications (if present) based on notification parameters 370 identified by the comparison. In one embodiment, server 120 may use the one or more notification parameters provided in notification subscription 360 to identify a subset of notification parameters (e.g., identified notification parameters 370) from the set of identified notification types. Server 120 may provide notifications filtered based on identified notification parameters 370 to client 110.

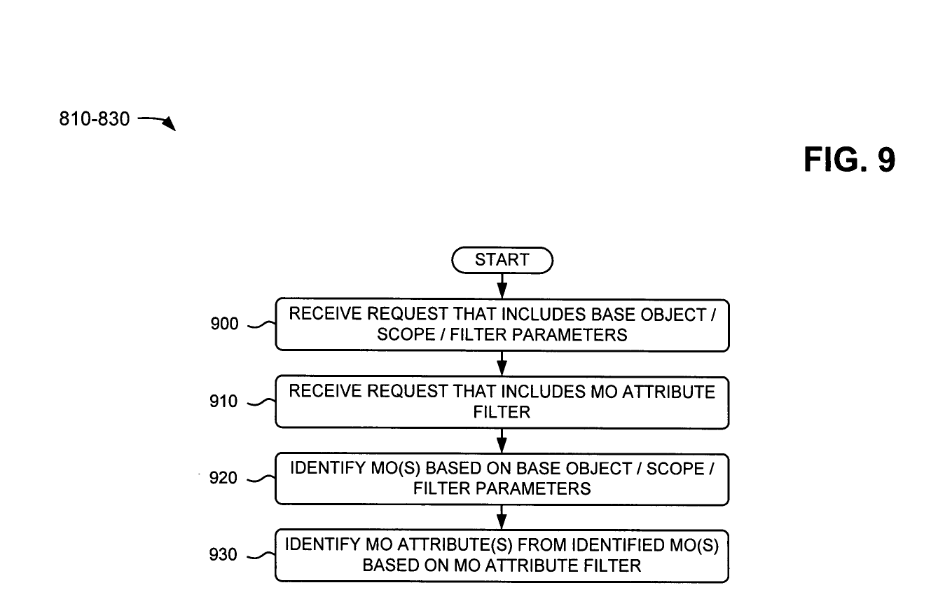

Process blocks 810-830 may include the process blocks depicted in FIG. 9. As illustrated in FIG. 9, process blocks 810-830 may include receiving a request that includes base object, scope, and/or filter parameters (block 900), and receiving a request that includes a managed object attribute filter (block 910). For example, in embodiments described above in connection with FIG. 6, managed object information request 340 may include managed object class name field 600, managed object attribute fields 610, and/or other request information field 620. Other request information 620 may include information that identifies managed object information to be retrieved. In one example, other request information 620 may include a base object parameter (e.g., “baseObjectInstance”) identifying a managed object class associated with managed object information to be retrieved, a scope parameter defining a type of scoping used for a request operation, and/or a filter parameter defining a filter to be passed by objects selected by the scope parameter. In another example, managed object class name field 600 and managed object attribute fields 610 may correspond to a managed object attribute filter that filters managed object information (e.g., information contained in database portion 400) based on managed object attributes.

As further shown in FIG. 9, process blocks 810-830 may include identifying the one or more managed objects based on the base object, scope, and/or filter parameters (block 920), and identifying the one or more managed object attributes from the one or more identified managed objects based on the managed object attribute filter (block 930). For example, in embodiments described above in connection with FIG. 6, server 120 may identify a set of managed objects based on managed object class name field 600 and/or other request information 620 (e.g., the base object, scope, and/or filter parameters) provided in managed object information request 340. Server 120 may use managed object attribute fields 610 provided in managed object information request 340 to identify a subset of managed object attributes (e.g., identified managed object attributes 350) from the set of identified managed objects.

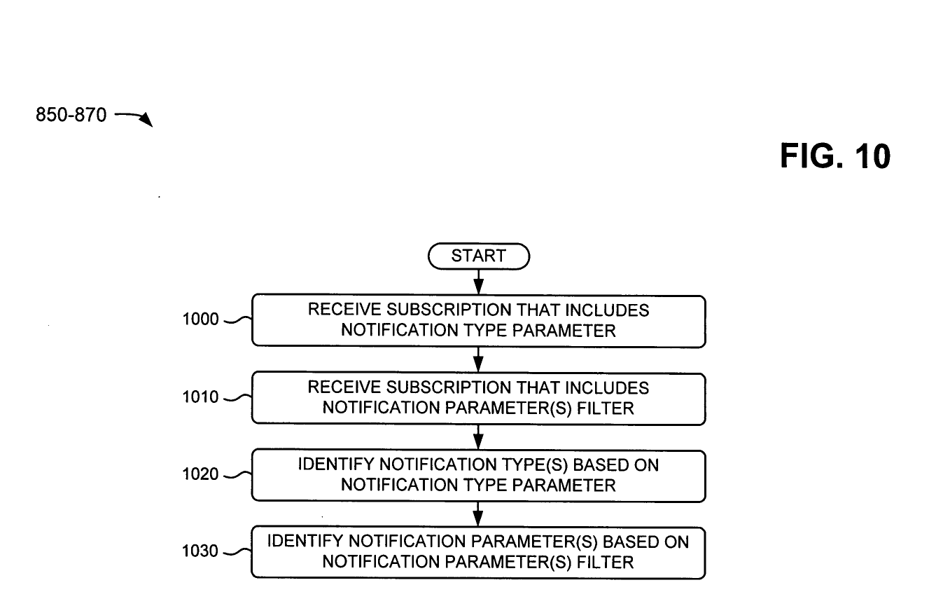

Process blocks 850-870 may include the process blocks depicted in FIG. 10. As illustrated in FIG. 10, process blocks 850-870 may include receiving a subscription that includes a notification type parameter (block 1000), and receiving a subscription that includes a notification parameter(s) filter (block 1010). For example, in embodiments described above in connection with FIG. 7, notification subscription 360 may include notification type field 700, notification parameter fields 710, and/or other subscription information field 720. Notification type field 700 may include information that identifies a type of notification to be retrieved. In one example, notification type field 700 and notification parameter fields 710 may correspond to a notification parameter filter that filters notifications (e.g., information contained in database portion 400) based on notification parameters.

Returning to FIG. 10, process blocks 850-870 may include identifying the one or more notification types based on the notification type parameter (block 1020), and identifying the one or more notification parameters based on the notification parameter(s) filter (block 1030). For example, in embodiments described above in connection with FIG. 7, server 120 may identify a set of notification types based on notification type field 700 provided in notification subscription 360. Server 120 may use notification parameter fields 710 provided in notification subscription 360 to identify a subset of notification parameters (e.g., identified notification parameters 370) from the set of identified notification types.

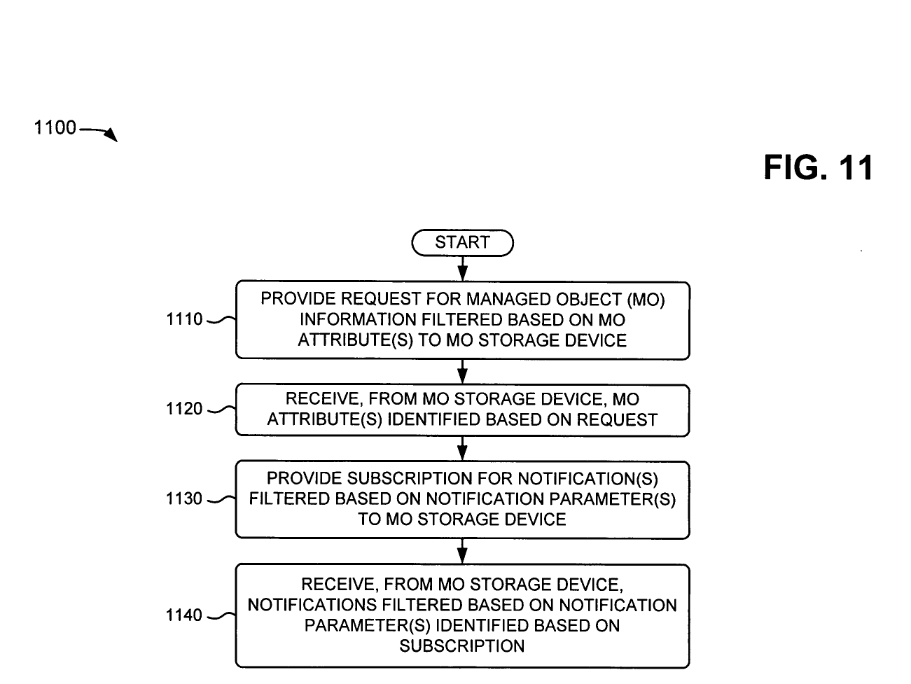

FIGS. 11-13 depict flow charts of an exemplary process 1100 for retrieving filtered managed object information and/or notifications according to embodiments described herein. In one embodiment, process 1100 may be performed by hardware and/or software components of client 110. In other embodiments, process 1100 may be performed by hardware and/or software components of client 110 in combination with hardware and/or software components of another device (e.g., communicating with client 110).

As illustrated in FIG. 11, process 1100 may begin with providing a request for managed object information, filtered based on one or more managed object attributes, to a managed object storage device (block 1110), and receiving, from the managed object storage device, one or more managed object attributes based on the request (block 1120). For example, in embodiments described above in connection with FIG. 3, if one of clients 110 wishes to retrieve managed object information from database 310, client 110 may generate and provide managed object information request 340 to server 120. Managed object information request 340 may include information associated with a managed object class name, one or more managed object attributes associated with the managed object class, and/or other request information. Server 120 may receive managed object information request 340, may compare one or more portions of managed object information request 340 to the information contained in database 310, and may generate identified managed object attributes 350 based on the comparison. In one example, server 120 may identify a set of managed objects based on the managed object class name provided in managed object information request 340. Server 120 may use the one or more managed object attributes provided in managed object information request 340 to identify a subset of managed object attributes (e.g., identified managed object attributes 350) from the set of identified managed objects. Server 120 may provide identified managed object attributes 350 to client 110.

Returning to FIG. 11, a subscription for one or more notifications, filtered based on one or more notification parameters, may be provided to the managed object storage device (block 1130), and one or more notifications filtered based on notification parameters may be received from the managed storage device based on the subscription (block 1140). For example, in embodiments described above in connection with FIG. 3, if client 110 wishes to subscribe to notifications from database 310, client 110 may generate and provide notification subscription 360 to server 120. Notification subscription 360 may include information associated with a notification type, one or more notification parameters associated with the notification type, and/or other subscription information. Server 120 may receive notification subscription 360, may compare one or more portions of notification subscription 360 to the information contained in database 310, and may generate notifications (if present) based on notification parameters 370 identified by the comparison. In one example, server 120 may identify a set of notification types based on the notification type provided in notification subscription 360. Server 120 may use the one or more notification parameters provided in notification subscription 360 to identify a subset of notification parameters (e.g., identified notification parameters 370) from the set of identified notification types. Server 120 may provide notifications based on identified notification parameters 370 to client 110.

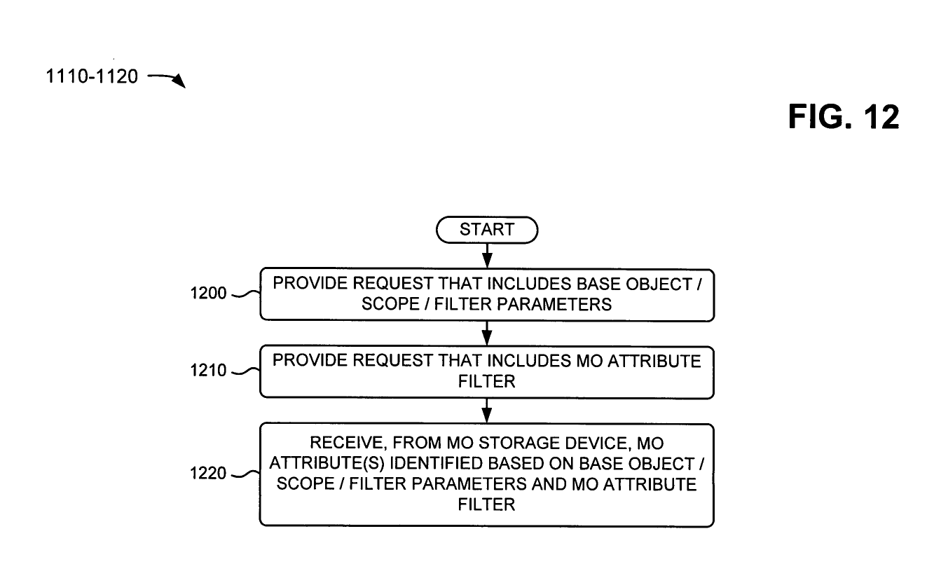

Process blocks 1110-1120 may include the process blocks depicted in FIG. 12. As illustrated in FIG. 12, process blocks 1110-1120 may include providing a request that includes a base object parameter, a scope parameter, and/or a filter parameter (block 1200), and providing a request that includes a managed object attribute filter (block 1210). For example, in embodiments described above in connection with FIG. 6, managed object information request 340 may include managed object class name field 600, managed object attribute fields 610, and/or other request information field 620. Other request information 620 may include information that identifies managed objects to be retrieved. In one example, other request information 620 may include a base object parameter (e.g., “baseObjectInstance”) identifying a managed object class associated with managed object information to be retrieved, a scope parameter defining a type of scoping used for a request operation, and/or a filter parameter defining a filter to be passed by objects selected by the scope parameter. In another example, managed object class name field 600 and managed object attribute fields 610 may correspond to a managed object attribute filter that filters managed object information (e.g., information contained in database portion 400) based on managed object attributes.

As further shown in FIG. 12, process blocks 1110-1120 may include receiving, from the managed object storage device, the one or more managed object attributes identified based on the base object, scope, and/or filter parameters and the managed object attribute filter (block 1220). For example, in embodiments described above in connection with FIG. 6, server 120 may identify a set of managed objects based on managed object class name field 600 and/or other request information 620 (e.g., the base object, scope, and/or filter parameters) provided in managed object information request 340. Server 120 may use managed object attribute fields 610 provided in managed object information request 340 to identify a subset of managed object attributes (e.g., identified managed object attributes 350) from the set of identified managed objects. Server 120 may provide identified managed object attributes 350 to client 110.

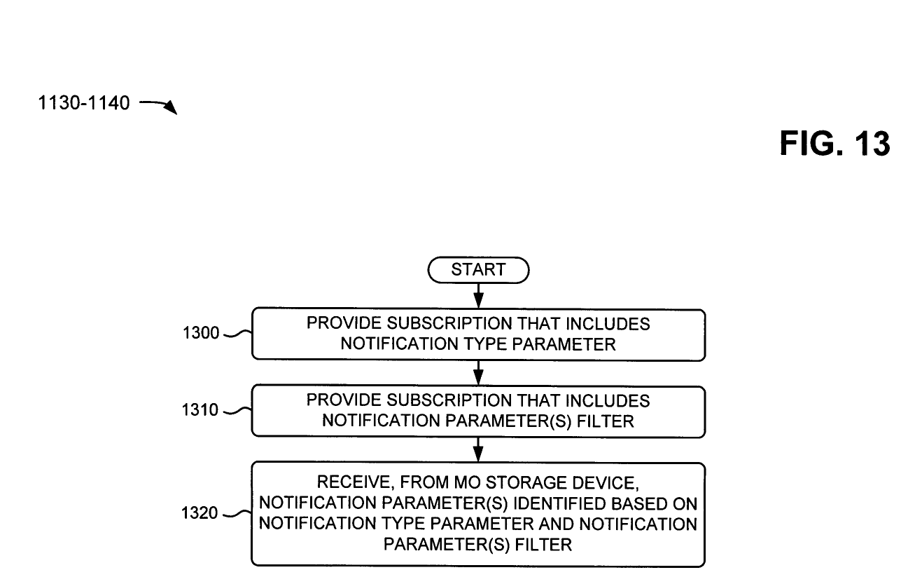

Process blocks 1130-1140 may include the process blocks depicted in FIG. 13. As illustrated in FIG. 13, process blocks 1130-1140 may include providing a subscription that includes a notification type parameter (block 1300), and providing a subscription that includes a notification parameter(s) filter (block 1310). For example, in embodiments described above in connection with FIG. 7, notification subscription 360 may include notification type field 700, notification parameter fields 710, and/or other subscription information field 720. Notification type field 700 may include information that identifies a type of notification to be retrieved. In one example, notification type field 700 and notification parameter fields 710 may correspond to a notification parameter filter that filters notifications (e.g., information contained in database portion 400) based on notification parameters.

Returning to FIG. 13, process blocks 1130-1140 may include receiving, from the managed object storage device, the one or more notification parameters identified based on the notification type parameter and the notification parameter(s) filter (block 1320). For example, in embodiments described above in connection with FIG. 7, server 120 may identify a set of notification types based on notification type field 700 provided in notification subscription 360. Server 120 may use notification parameter fields 710 provided in notification subscription 360 to identify a subset of notification parameters (e.g., identified notification parameters 370) from the set of identified notification types. Server 120 may provide notifications filtered based on identified notification parameters 370 to client 110.

Embodiments described herein may provide systems and/or methods that filter managed object information and/or notifications based on managed object attributes and/or notification parameters, respectively.

Embodiments described herein may provide a variety of advantages. For example, the managed object attribute filter described herein may permit very fine grained queries to be executed on network management information that is not supported in current systems. When current systems query one attribute from large datasets (e.g., a telecommunication system that includes tens of thousands of managed objects), the query results in an enormous amount of information being retrieved, including all managed object attributes. This is time consuming and requires a significant amount of bandwidth to transfer data that is ultimately not required. The managed object attribute filter described herein may prevent such as result.

In scenarios where only a status (e.g., whether there is a critical alarm or not) of a managed object is desired, current systems forward all notification information, including all details of the alarms. The notification parameter filter described herein prevents such a result. For example, with the notification parameter filter described herein, it is possible to filter based on high level data, and to collect details required for troubleshooting based on the filtered high level data.

The foregoing description of embodiments provides illustration and description, but is not intended to be exhaustive or to limit the invention to the precise form disclosed. Modifications and variations are possible in light of the above teachings or may be acquired from practice of the invention. For example, while series of blocks have been described with regard to FIGS. 8-13, the order of the blocks may be modified in other embodiments. Further, non-dependent blocks may be performed in parallel.

It should be emphasized that the term “comprises/comprising” when used in this specification is taken to specify the presence of stated features, integers, steps or components but does not preclude the presence or addition of one or more other features, integers, steps, components or groups thereof.

It will be apparent that exemplary embodiments, as described above, may be implemented in many different forms of software, firmware, and hardware in the embodiments illustrated in the figures. The actual software code or specialized control hardware used to implement these aspects should not be construed as limiting. Thus, the operation and behavior of the aspects were described without reference to the specific software code—it being understood that software and control hardware could be designed to implement the aspects based on the description herein.

Further, certain portions of the invention may be implemented as “logic” that performs one or more functions. The logic may include hardware, such as an application specific integrated circuit, a field programmable gate array, a processor, or a microprocessor, or a combination of hardware and software.

Even though particular combinations of features are recited in the claims and/or disclosed in the specification, these combinations are not intended to limit the invention. In fact, many of these features may be combined in ways not specifically recited in the claims and/or disclosed in the specification.

No element, block, or instruction used in the present application should be construed as critical or essential to the invention unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

What is claimed is:

1. A method, performed by a device associated with a network, comprising:
receiving, from a requester, a request for managed object information filtered based on a managed object attribute;
identifying a managed object based on the request;
identifying, based on the request, the managed object attribute from the identified managed object; and
providing the identified managed object attribute to the requestor.

2. The method of claim 1, further comprising:
receiving managed object information from the requester; and
storing the managed object information in a database.

3. The method of claim 1, where receiving a request, comprises:
receiving a request that includes a base object parameter, a scope parameter, and a filter parameter; and
receiving a request that include a managed object attribute filter.

4. The method of claim 3, where:
identifying a managed object based on the request comprises identifying the managed object based on the base object parameter, the scope parameter, and the filter parameter; and
identifying a managed object attribute comprises identifying the managed object attribute based on the managed object attribute filter.

5. The method of claim 1, further comprising:
receiving, from the requester, a subscription for a notification filtered based on a notification parameter;
identifying a notification type based on the subscription;
identifying, based on the subscription, the notification parameter from the identified notification type; and
providing a notification filtered based on the identified notification parameter to the requestor.

6. The method of claim 5, where receiving a subscription, comprises:
receiving a subscription that includes a notification type parameter; and
receiving a subscription that includes a notification parameter filter.

7. The method of claim 6, where:
identifying a notification type based on the subscription comprises identifying the notification type based on the notification type parameter; and
identifying the notification parameter comprises identifying the notification parameter based on the notification parameter filter.

8. A method, performed by a device associated with a network, comprising:
providing, to a managed object storage device, a request for managed object information filtered based on a managed object attribute; and
receiving, from the managed object storage device, the managed object attribute identified based on the request.

9. The method of claim 8, further comprising:
providing managed object information to a database associated with the managed object storage device.

10. The method of claim 8, where:
providing a request comprises:
providing a request that includes a base object parameter, a scope parameter, and a filter parameter, and
providing a request that includes a managed object attribute filter; and
receiving the managed object attribute comprises receiving the managed object attribute based on the base object parameter, the scope parameter, the filter parameter, and the managed object attribute filter.

11. The method of claim 8, further comprising:
providing, to the managed object storage device, a subscription for a notification filtered based on a notification parameter; and
receiving, from the managed object storage device, a notification filtered based on the notification parameter identified based on the subscription.

12. The method of claim 11, where:
providing a subscription comprises:
providing a subscription that includes a notification type parameter, and
providing a subscription that includes a notification parameter filter; and
receiving a notification comprises receiving a notification filtered based on the notification parameter identified based on the notification parameter and the notification parameter filter.

13. A device associated with a network, comprising:
processing logic to:
receive, from a client device, a request for managed object information filtered based on one or more managed object attributes,
identify one or more managed objects based on the request,
identify, based on the request, the one or more managed object attributes from the one or more identified managed objects, and
provide the one or more identified managed object attributes to the client device.

14. The device of claim 13, where the managed object information comprises at least one of:
an abstract representation of network functions,
an abstract representation of managed devices associated with the network, or
information relating to a resource within the network that is managed through the use of operation, administration, maintenance, and provisioning (OAMP) protocols.

15. The device of claim 13, where the request comprises:
a base object parameter,
a scope parameter,
a filter parameter, and
a managed object attribute filter.

16. The device of claim 15, where the processing logic is further configured to:
identify the one or more managed objects based on the base object parameter, the scope parameter, and the filter parameter, and
identify, based on the managed object attribute filter, the one or more managed object attributes from the one or more identified managed objects.

17. The device of claim 13, where the processing logic is further configured to:
receive, from the client device, a subscription for one or more notifications filtered based on one or more notification parameters,
identify one or more notification types based on the subscription,
identify, based on the subscription, the one or more notification parameters, from the one or more identified notification types, and
provide one or more notifications, filtered based on the one or more identified notification parameters, to the client device.

18. The device of claim 17, where the subscription comprises:
a notification type parameter, and
a notification parameter filter.

19. The device of claim 18, where the processing logic is further configured to:
identify the one or more notification types based on the notification type parameter, and
identify, based on the notification parameter filter, the one or more notification parameters from the one or more identified notification types.

20. The device of claim 13, where the device comprises a server device.

21. A device associated with a network, comprising:
processing logic to:
provide, to a managed object storage device, a request for managed object information filtered based on one or more managed object attributes, and
receive, from the managed object storage device, the one or more managed object attributes identified based on the request.

22. The device of claim 21, where the device comprises a client device.

23. The device of claim 21, where the request comprises:
a base object parameter,
a scope parameter,
a filter parameter, and
a managed object attribute filter.

24. The device of claim 23, where the processing logic is further configured to:
receive the one or more managed object attribute based on the base object parameter, the scope parameter, the filter parameter, and the managed object attribute filter.

25. The device of claim 21, where the processing logic is further configured to:
provide, to the managed object storage device, a subscription for one or more notifications filtered based on one or more notification parameters, and
receive, from the managed object storage device, one or more notifications filtered based on the one or more notification parameters identified based on the subscription.

26. The device of claim 25, where the subscription comprises:
a notification type parameter, and
a notification parameter filter.

27. The device of claim 26, where the processing logic is further configured to:
receive the one or more notifications filtered based on the one or more notification parameters identified based on the notification parameter and the notification parameter filter.
